(19) United States
(12) Patent Application Publication
(10) Pub. No.: US 2013/0154934 A1
(43) Pub. Date: Jun. 20, 2013

(54) Electronic Family Tree Generation and Display System

(71) Applicant: AIV Technology LLC, Hamden, CT (US)

(72) Inventor: Klaus Peters, Hamden, CT (US)

(73) Assignee: AIV Technology LLC, Hamden, CT (US)

(21) Appl. No.: 13/752,829

(22) Filed: Jan. 29, 2013

Related U.S. Application Data
(62) Division of application No. 12/807,106, filed on Aug. 27, 2010.

(51) Int. Cl. G06T 3/40

(52) U.S. Cl. CPC G06T 3/40
USPC 345/163; 345/156; 345/173

(57) ABSTRACT

An interactive electronic picture organization and display system stores pictures that include images of users' relatives and/or friends and enables the user to crop the images from the pictures into portraits of varying intimacy or social closeness values. The cropped portraits are stored with identification information and age indices and with specified preferred social proximities for the various individuals. Family trees are generated showing portraits of family tree members with appropriate age indices and preferred social closeness indices and are modified by simply mouse-clicking on displayed portraits. Collections of portraits of selected individuals exemplarily of different generations with an average generational age difference or the same age index (all as children, all as parents or grandparents, etc.) may be displayed. Life stories can be developed, collated to portraits of different age indices.

### BACKGROUND OF THE INVENTION

The present invention relates to an electronic system of associate method for generating, organizing and presenting portrait-style pictures of related individuals. More particularly, the invention relates to pictorially represented family trees and ancillary services.

The genealogy business is prospering, particularly in cyberspace. Many online companies have arisen for tracing, gathering, organizing, and presenting genealogic information. Such online services typically enable multiple users (e.g., relatives) to enter information to build up the family tree. Shared time lines are also provided.

One particular online service, describing itself as the “world's largest” family tree, is geared towards user-approved publishing of parts of private family trees, especially those of celebrities, business people and artists, who what to disseminate their professional history, business and personal information. The service makes money from providing search services.

Another online service allows the user to build a family tree online. Friends and family are invited to view or update the site. Each private and secure website is loaded with photos, charts, reports, maps, relationships, events and stories. Names of relatives are added or imported via a GEDCOM file and instantly create your website. The site can create custom newsletters for each member with birthday and anniversary reminders, recent site activity and send them out every two weeks.

A further online genealogy service allows a user to view and edit his or her genealogy on the website. The site has full editing capabilities, full privacy functions, can import from GEDCOM files, and supports multimedia-like photos and document images. This online service also simplifies the process of collaborating with others working on a user's family tree. The user's latest genealogy information is always on the website and available for others to see.

Online services typically display family tree data in a classical format as horizontal genealogical trees with all children depicted in all generations. This convention makes a family tree very cumbersome to navigate and frequently causes the user to “lose sight” of directly related descendants (four generations are generally the maximum for social memory).

The new Word Wide Web 2 (WWW2) is changing social awareness and accommodating privacy concerns with server-controlled full 128-bit encryption of the Internet data exchange and user-controlled personal data access, sharing and publication. In addition, there is a growing expectation of deeper personal experiences not only at the friends level (Facebook, e-Harmony etc) but also at the family level.

### OBJECTS OF THE INVENTION

It is an object of the present invention to provide an electronic family tree display system and/or method that enhances family relationships and the family experience.

It is another object of the present invention to provide an electronic family tree display system and/or method that relies to a large extent on pictorial representations.

A further object of the present invention is to provide an electronic family tree display system and/or method that facilitates the generation of suitable portrait pictures for family tree and family photo collection displays.

These and other objects of the present invention will be apparent from the drawings and descriptions herein. Although every object of the invention is attained in at least one embodiment of the invention, there is not necessarily any embodiment which attains all of the objects of the invention.

### SUMMARY OF THE INVENTION

The present invention contemplates an online service providing a website where families and friends meet and connect. The entire content of the website is created by users and shared with family members in a private interactive web environment. All communicate through a “living picture tree” displaying portraits of family members via an interactive web-based relational picture management application.

More particularly, the present invention is directed to an interactive electronic picture organization and display system. The system stores pictures that include images of users' relatives and/or friends and enables the user to crop the images from the pictures into portraits of varying intimacy or social closeness values, to store the cropped portraits with identification information and age indices, to specify preferred social proximities for the various individuals, to call up family trees showing portraits of family tree members with appropriate age indices and preferred social closeness indices, to show portraits of selected individuals exemplarily of different generations but with the same age index (all as children, all as parents or grandparents, etc.), to develop life stories collated to portraits of different age indices, as well as other activities.

The cropping feature of the invention uses an electronic computational device to access a picture in electronic form including an image of a person's face showing the person's head and facial features. The accessed picture is shown on a display of the computational device. An input peripheral of the computational device is used to designate or identify a location of a selected one of the person's facial features on the picture, for example, the mouth, the nose or the eyes. The peripheral is further used to designate a location above the person's head. One then operates the computational device to trigger an electronic cropping of the picture to generate a cropped portrait wherein the selected one of the person's facial features is located at a predetermined position in the cropped portrait and wherein an upper margin of the cropped portrait is at least proximate the designated location above the person's head.

The computational device may be a cell phone or other hand-held electronic device that includes a camera. Alternatively, the camera may be a separate device. In any case, the camera may be used to generate pictures from which the cropped portraits are derived.

The peripheral used to communicate instructions to the computational device is typically an integral part of the computational device, for instance, a key board, key pad, mouse pad, touch-screen, etc.

The portraits and optionally the pictures may be uploaded, for instance, via a wireless link, to a central server computer that maintains the pictures and portraits in a database for access by authorized individual users. Accordingly, the computational device may have computer network access capability. In that case, where the picture is previously stored in the server computer's database, for instance by another user, the using of the computational device to access the picture includes operating the computational device to communicate with a server computer over a computer network. The operating of the computational device to trigger a storing of the cropped portrait comprises operating the computational device to transmit a signal to the server computer.

It is understood that the user operates the computational device to trigger a storing of the cropped portrait. The cropped portrait may be stored in the memory of the computational device and/or in the server database. The storing of the cropped portrait may be automatically implemented upon the operating of the peripheral to designate the location above the person's head and the computation of the portrait's perimeter.

The relative size of the individual's facial image in the cropped portrait depends on the feature that is selected. The portrait is proportioned automatically so that the selected feature is at or near the geometric center of the portrait. Consequently, if the mouth is selected, the face is smaller relative to the frame of the picture than if the nose or eyes are selected. With the eyes selected, the face occupies a maximum area of the portrait, thus giving the impression of intimacy or closeness of the individual portrayed.

More particularly, the operating the computational device to generate a cropped portrait of the picture includes registering or storing, from the picture image, a pixel area with a length and a width (or other dimensions, for non-rectangular portrait perimeters) in predetermined ratios with respect to a distance between the designated location of the selected one of the person's facial features on the picture and the designated location above the person's head.

The computational device may specify a particular feature of which the user is to identify the location on an accessed picture. Upon the user's identification of the feature's location and the top of the pictured individual's head, a cropped portrait is automatically produced with the presented facial feature at the center of the portrait in accordance and with a perimeter having a predetermined shape and predetermined proportions.

Viewing the portraits of different social closeness values resonates psychologically in feelings of certain levels of social closeness. Mouth-centered portraits are perceived as being socially neutral, nose-centered portraits are perceived as being personal, and eye-centered portraits are perceived as being intimate. Each of these three types can be deliberately produced using the center-crop technology discussed above. The center crop technology uses a single mouse or cursor action for generating a crop-frame symmetrical to the start point at pre-set or variable proportions. It requires only one action step, namely, dragging from the selected center the crop frame to just above the head. Releasing the mouse initiates the cropping. This single action step may be defined by two clicks of a mouse key, a “downward” first click identifying the selected center point and an “upward” second click identifying the upper limit to the frame. Since facial features have an average proportion, all three social portrait types can be automatically generated with the draw action on either of the preset facial features. Applied to portrait cropping it automatically generates all three social portrait types.

Pursuant to further features of the present invention, the method further comprises operating the computational device to trigger a storing of at least one additional cropped portrait, the additional cropped portrait being centered on another one of the person's facial features. Where the selected facial feature is the mouth (the user having identified the center of the mouth), two additional cropped portraits may be generated that are centered on the subject's nose and eyes, respectively. Pattern recognition software may be used to identify and locate the alternative features. Alternatively, the user may be prompted to identify the locations of the other facial features on the cropped portrait or the original picture.

The operating of the computational device to trigger the electronic cropping may be automatic upon the operating of the peripheral to designate the location above the person's head.

Where the computational device has computer network access capability, the server may be operated to execute the cropping process. In that event, the use of the computational device to trigger the electronic cropping includes dispatching a signal from the computational device to the server computer. Alternatively, as indicated above, the computational device crops the picture to generate the cropped portrait and uploads the cropped portrait to the server computer.

Where the peripheral is a computer mouse, the operating of the peripheral to designate or identify a location of the selected one of the person's facial features on the picture including pointing and clicking on the selected one of the person's facial features. Where the peripheral is a touch pad or screen, the operating of the peripheral to designate or identify a location of the selected one of the person's facial features on the picture includes touching the pad or screen at the image of the selected one of the person's facial features.

Typically, various family members are designated or authorized users and may contribute to the common family trees, displays of common-age portrait collections, life stories, and so forth. In a subscription online service, members are typically relatives of the owner and are invited by the owner of a tree to join the owner's tree and contribute.

A method for representing a family tree including at least two members at each of a plurality of generational levels comprises, in accordance with the present invention, providing access to a database that stores, for each of a plurality of family tree members, a plurality of portrait-type pictures each assigned a respective predetermined age index and depicting the respective family member within an age range corresponding to that respective age index. The tree representation method further comprises displaying on a display screen of an electronic device a first family tree having a parent level and showing portrait pictures from the database of members of the family tree, wherein the displayed pictures have age indices matching generational levels of the members of the family tree so that family members of a generational level above a given generational level appear to be between approximately 20 years and approximately 40 years older than family members of the given generational level. An input peripheral of the electronic device is used to select a family member on a generational level other than the parent level, whereupon a second family tree is displayed on the display screen wherein a portrait picture of the selected family member having a parent-level age index is displayed at the parent level and wherein portrait pictures of other family members from the first family tree are displayed at new generational levels different from respective generational levels in the first family tree and with age indices consistent with the new generational levels and with the display of the selected family member at the parent level.

Where family tree members are assigned (by a user) preselected social closeness values or indices defining the degree to which an associated head image fills available space within a perimeter of the respective portrait picture, the displaying of the first family tree and the second family tree includes displaying family pictures of family members in accordance with the respective preselected social closeness values or indices.

The present invention recognizes that, for one or more family members, pictures of that family member at one or more of the generational levels may not be available. In the case of unavailability of a portrait picture at a given generational level or age index, the system may be designed to select an available portrait picture that is closest in age value to the missing generational level or age index. Where portrait pictures with both older and younger age index values are available, the older one may be automatically selected for use in a family tree display. If no pictures of an individual family member are available (for instance, where the family member is a remote ancestor), a silhouette, graphic image, or other stock picture may be used.

Where the electronic device has computer network access capability and the database is associated with a server computer, the electronic device is operated to communicate with the server computer via a computer network. The displaying of the first family tree and the second family tree each includes' operating the electronic device to download portrait pictures for the first family tree and portrait pictures for the second family tree in encoded form from the server computer. The using of the peripheral of the electronic device to select the family member includes operating the electronic device to transmit a request to the server computer to produce, and transmit to the electronic device in encoded form, portrait pictures of family members for the second family tree in accordance with a position of the selected family member in the first family tree.

It is contemplated that the using of the peripheral to select a family member includes operating the electronic device to position a cursor on the selected family member's portrait picture in the first family tree.

A computer method for reviewing an electronic photo library comprises, in accordance with the present invention, providing access to a database that stores, for each of a multiplicity of individuals, a plurality of portrait pictures each assigned a respective predetermined age index and depicting the respective individual within an age range corresponding to that respective age index. The method further comprises displaying, on a display screen, a first collection of the portrait pictures from the database, wherein the displayed portrait pictures are of respective ones of the individuals and all share a common age index, and operating the computer to select a different age index. In response to the selecting of the different age index, a second collection of the portrait pictures from the database is displayed on the display, wherein the portrait pictures of the second collection are of the same individuals as depicted in the first collection and have the selected different age index.

Thus, the invention contemplates showing portrait pictures of members of different generations, where everyone is pictured within the same age range. Thus uncles and aunts are shown at the same age index or generational level (e.g., child, parent, grandparent, great grandparent) as their nieces, nephews and cousins.

Where the individuals are assigned a preselected social closeness value or index defining a degree to which an associated facial image fills available space within a perimeter of the respective portrait picture, the displaying of the first collection and the second collection includes displaying portrait pictures of selected individuals in accordance with respective preselected social closeness values or indices.

The age indices of the portrait pictures in the database may be defined by generational levels, such as child, parent, grandparent, great-grandparent, and possible great-great-grandparent. Alternatively, age indices of the portrait pictures may be defined by age ranges, for instance, in 20-year increments (from 0 to 20, from 21 to 40, from 41 to 60, from 61 to 80, and from 81 to 100). Alternatively, the age indices of the portrait pictures in the database may be approximate ages of the respective individuals when the respective portrait pictures were taken.

The present invention contemplates that the portrait pictures may be periodically updated to maintain a current inventory of contemporaneous likenesses. For the childhood years, one might store portrait pictures for baby, toddler, child, and teenager age ranges in general in small age increments.

A computer method for communicating life stories comprises, in accordance with the present invention, providing access to a database that stores, for each of a multiplicity of individuals, a plurality of portrait pictures each assigned a respective predetermined age index and depicting the respective individual within an age range corresponding to that respective age index. The method further comprises displaying, on a display of an electronic device, a collection of the portrait pictures from the database, wherein the displayed portrait pictures are of a single one of the individuals and have respective age indices. The portrait pictures of the collection are displayed in a chronological sequence. The electronic device (preferably, a computer) is operated to insert biographical textual material in association with each of the displayed portrait pictures so that the textual material appears on the display adjacent or aside the respective portrait pictures of the collection.

This method contemplates operating the computer to insert pictorial and multi-media type material into the life story, at appropriate points relative to the age sequence of portrait pictures.

The present invention provides an electronic family tree experience that puts the family at the center and enhances the awareness of growing up together in a family environment. The photographic record may be updated continuously, enabling family members to more easily keep in touch with one another and recollect or intensify family experiences.

A genealogical website in accordance with the present invention provides a novel type of genealogical family tree display template that centers on the family and uses two novel tools for depiction of family tree persons: yearly portraits collection and social portrait types. For the generation of these portraits it introduces a novel center-crop technology discussed above. The specific portrait technology enables a novel way for collecting and displaying social information in easy accessible genealogical information on relatives and their life stories.

### BRIEF DESCRIPTION OF THE DRAWINGS

FIG. 1 is a block diagram showing functional blocks of an electronic family tree display system in accordance with the present invention.

FIG. 2 is a flow-chart diagram showing steps carried out by an electronic device or network of devices in an electronic family tree display method in accordance with the present invention.

FIGS. 3 and 4 are diagrams of family picture trees in accordance with the present invention.

FIG. 5 is a schematic picture, illustrated a cropping technique in accordance with the present invention.

FIGS. 6-8 are portrait pictures of different social closeness indices for potential use in a family picture tree as shown in FIGS. 3 and 4, that are generated in part by the cropping technique of FIG. 5.

FIG. 9 is a partial diagram of a family picture tree schematically showing portraits of different social closeness indices or values pursuant to the present invention.

### DEFINITIONS

The term “computational device” is used herein to designate any electronic device with a display on which graphic and textual material may be reproduced for visual inspection and which can be programmed to execute mathematical functions. A computational device can take the form, for example, of a desktop computer, a laptop computer, a personal digital assistant, a cell phone, a touch screen pad, etc.

The term “picture” is used herein to denote any photograph, illustration, or graphic representation that includes a facial image of at least one individual. A picture may include facial images of more than one individual. The facial image may in some cases be only a simulation or symbolic representation of the face of an individual, as when a photograph or portrait of an individual is not available. Thus, a picture can be cropped pursuant to the invention to yield a portrait-type image suitable for inclusion on a family tree.

The term “facial feature” is used herein to designate major features that are present in every human face. The primary facial features for purposes of the present invention are the mouth, the nose, and the eyes. During a cropping process, a user typically operates an input peripheral to identify the middle of the mouth, or the tip of the nose, or a point on the bridge of the nose between the two eyes.

The term “input peripheral” is used herein to denote any electronic, electrical, mechanical, or optical device that enables a user to provide instructions and data to an electronic device. An input peripheral may be a keyboard, a keypad, a mouse, a touch-sensitive plate or screen, a voice recognition assembly with a sound sensor, etc.

The term “age index” is used herein to broadly designate an age range for an individual in a portrait. The age range for a particular age index may be identified numerically, for example, by a number spread such as 5 to 10 years old, 11 to 20 years old, 21 to 50 years old, 51 to 85 years old and 86 and older. Alternatively, the age range for a particular age index may be identified qualitatively such as by the age labels baby or toddler, young child, teenager, young adult, middle-aged adult, and old adult. Another qualitative indexing would include baby or toddler, young child, teenager, parent, grandparent, and great grandparent.

The term “crop-type index” or “social closeness index” is used herein to designate the degree of social intimacy represented or embodied in different types of cropped portraits depending on the extent to which the head fills the available space within the portrait perimeter. For instance, three nearness types are mouth centered, nose centered, and eyes centered, proceeding from most distant and least familiar to closest and most intimate. Any user of the family tree display system may designate, for each member of their family tree, a preference as to the social closeness index of the respective displayed picture. For instance, distant relatives would most likely be displayed with portraits cropped to the most distant and least intimate degree, with mouth centered and the smallest ratio of head area to background area in the picture frame. Parents, siblings and wives might be displayed with portraits cropped to an intermediate distance and intimacy level, with nose centered and a middle ratio of head area to background area in the picture frame. Children would most likely be displayed with portraits cropped to the closest distance and highest intimacy level, with eyes centered and the largest ratio of head area to background area in the picture frame.

The term “family member” is used herein to designate an individual who is identified as a member of a family tree. Such an individual may or may not be a blood relative of other members of the family tree. A family member may be a spouse, a foster parent or foster child, a godparent or godchild, an adoptive relation, a social partner, a close friend, etc.

The word “default” when applied to a portrait or picture is used herein to designate a picture of an individual to be displayed in a family tree or photo library set when no designation of preference has been set. For many individuals from prior generations, there may be only one picture entry, which would naturally serve as the default. Generally, when there are multiple pictures, for instance, from different photographs, an individual user may designate a default for each family member for use by that individual user. When no picture is available, a default may be a neutral average silhouette of a person or may be selected from a library of male and female pictures ordered by year range or era (late nineteenth century, middle twentieth century, etc.). A default portrait may be characterized in part by a preselected age index and a preselected social closeness index. The system of the invention may accommodate user preferences as to all of these features. Thus, the user may select the age index and social-distance index for any family member to be displayed in a family tree or a library review collection.

The term “family tree” refers herein to a diagram of generations of related individuals represented, to the extent permitted by the degree of completeness of a portrait library, by age-indexed portraits. Each authorized user of the electronic portraiture system described herein may have a default tree where that individual is positioned at a parent level, with one or more spouses at the same level, children on a level below, parents and parents-in-law on a level above, grandparents a level above that and so forth. The relationships of the individual family tree members need not be blood relationships, but can be any relationship designated by the individual user. Thus children may be god-children, nieces or nephews, adopted children, etc. People designated as “parents” may in fact be teachers or mentors, or older professional colleagues, etc. With reference to the latter, the entire family tree may possibly be used for members of an organization such as a law firm or other business.

### DETAILED DESCRIPTION

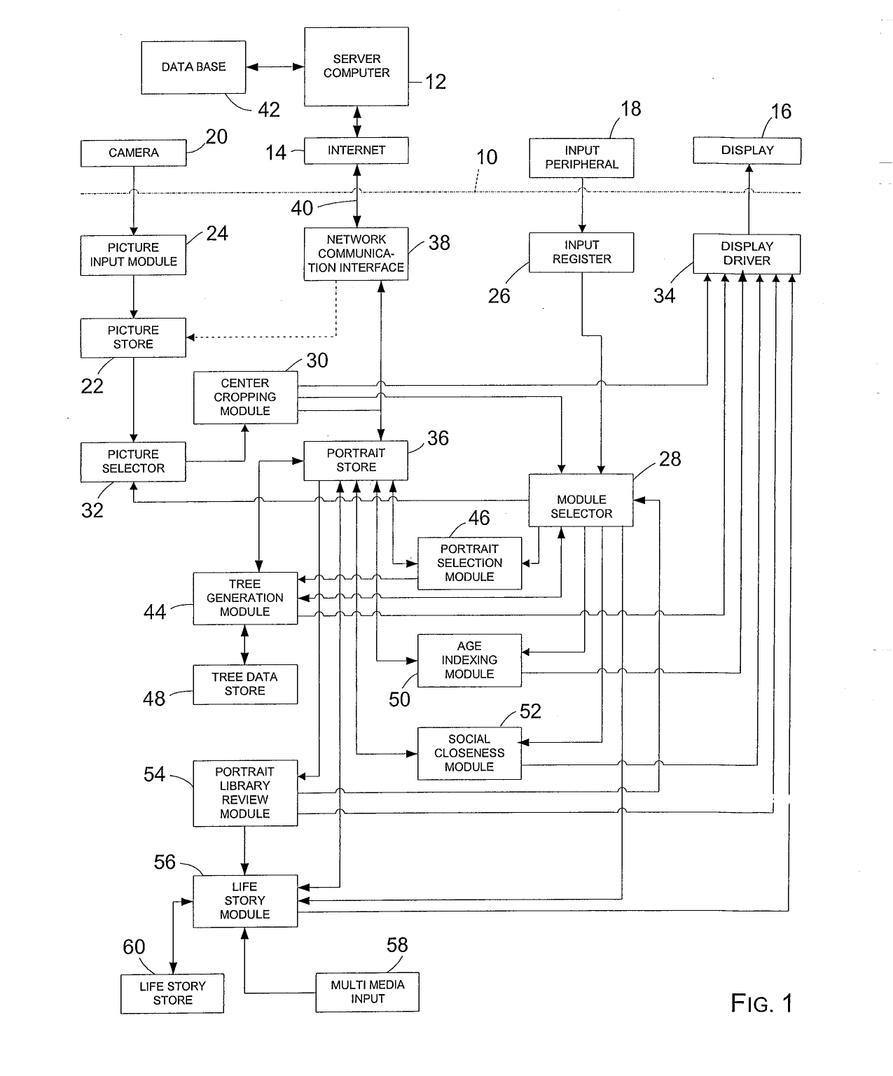

FIG. 1 depicts an electronic family tree display system where the functional blocks are resident in an electronic device 10 with computational capability such as a desktop computer, a laptop computer, a netbook computer, a personal digital assistant with Internet access, a cellular telephone, etc. It should be apparent that several of the illustrated functional modules may be resident in a server computer 12 accessible via the Internet 14 or other computer network. Accordingly, in response to instructions from electronic device 10, server computer 12 may implement certain computational, data retrieval and data organization functions and transmit the desired results to electronic device 10 for presentation to a user via a display 16. The user enters instructions into electronic device 10 via an input peripheral 18, which, like display 16, may be integrally associated with the electronic device. Input peripheral 18 may take any appropriate form for positioning a cursor or otherwise indicating a position on the screen of display 16 and may be a combination of input peripherals such as a keypad and a touch-sensitive screen or a keyboard and a mouse.

Various modules illustrated in FIG. 1 may be implemented via generic microprocessor circuits modified by programming to carry out the respective functions.

Electronic device 10 may be equipped with a digital camera 20 for taking photographs of family members to be uploaded as pictures to a picture store 22 via a picture input module or interface 24. Alternatively, camera 20 may be a separate device that is connectable to electronic device 10 or to server computer 12 for uploading photographic pictures of individuals for use in forming portraits of various social closeness values as discussed hereinafter. The pictures will each include at least an image of at least one person's face showing the person's head and facial features.

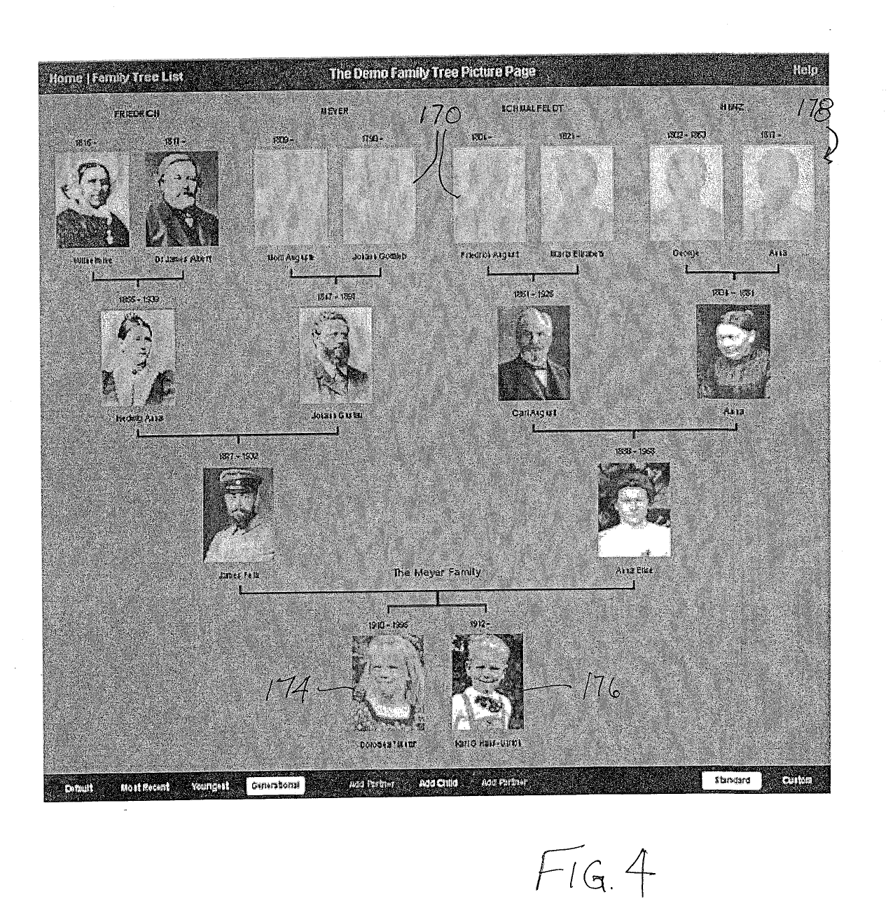

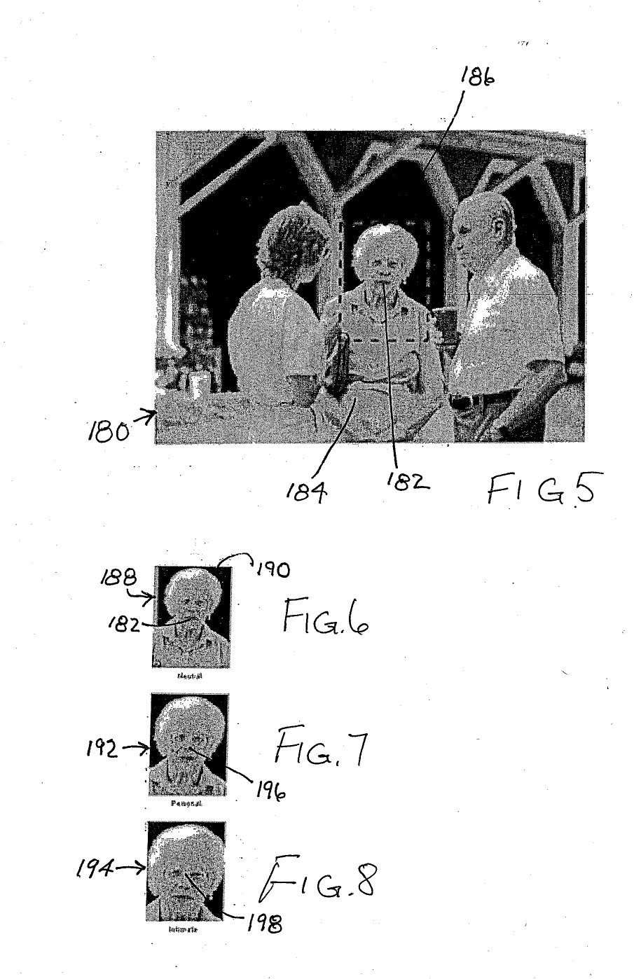

Input peripheral 18 is connected via a register or buffer 26 to a module selector 28 that serves to distribute instructions from the input peripheral to the various functional modules of electronic device 10. For instance, module selector 28 is connected to a cropping module 30 via a picture selector 32. In response to user input, picture selector 32 retrieves a desired picture 180 (FIG. 5) from store 22 and presents the picture to cropping module 30. Module 30 is connected to display 16 via a display driver or interface 34 and thereby presents the desired picture to the user. The user operates input peripheral 18 to select two points on the picture shown on display 18, namely, a facial feature (preferably the mouth 182, FIG. 5) of a desired pictured individual 184 and a point 186 at the top of or just above the pictured person's head. In response to this dual-click or click-and-drag selection by the user via input peripheral 18, and preferably automatically upon receiving a signal encoding the second selected location, cropping module extracts a portion of the displayed picture with a predetermined (typically rectangular) perimeter and having (a) the selected facial feature located at the center of the extracted picture portion and (b) an upper margin passing through or proximate to the selected upper point. The portion of the picture so extracted has predetermined proportions and constitutes a portrait picture (188, FIG. 6) for purposes of display in a family tree as described in detail hereinafter. Cropping module 30 inserts the cropped picture 188 into a portrait store 36. Where portrait store is located in electronic device 10, cropping module may additionally transmit the cropped picture 188 to server computer 12 via a network communication interface 38 and a hard-wired or wireless link 40 for storage in an additional portrait store (not separately illustrated) of a database 42 of the server computer.

Input peripheral 18 of electronic computational device 10 is typically operated to designate or identify a location of the mouth of an image in a selected picture shown on display 18. Where the cropping module 30 is resident on server computer 12, the electronic computation device (e.g., a module substituting for the depicted cropping module 30) transmits a signal to server computer 12 via communication interface 38 and the Internet 14 to trigger an electronic cropping of the picture by the cropping module of server computer 12. The cropping generates a cropped portrait 188 (FIG. 6) wherein the mouth 182 is located at center position in the cropped portrait and wherein an upper margin 190 of the cropped portrait is at least proximate the designated location above the person's head. In this scenario, a portrait store (36) is also resident on server computer 12, for instance, as part of database 42, so that the cropped picture or portrait picture 188, together with automatically generated sister portraits 192 (FIG. 7) and 194 (FIG. 8) are stored in the server's portrait store. Sister portraits 192 and 194 are automatically generated to position the nose 196 and the eyes 198 of the pictured individual 184 at the centers of the respective portraits.

It is to be recognized that it is only necessary to store one portrait picture, for instance, a mouth-centered portrait 188 (FIG. 6). The nose- and eyes-centered portraits 192 and 194 (FIGS. 7 and 8) can be automatically generated using pattern recognition software to identify the locations of the tip of the nose 196 and the centerline (not separately designated) of the eyes 198. The proportions of the distances between the top of the head and the center of the eyes, the nose and the mouth are approximately 1:1.28:1.58 and may vary only slightly between different persons, even persons of different ethnicities.

In the embodiment illustrated in FIG. 1, with cropping module 30 and portrait store 36 resident on the electronic computational device 10, the portraits (as cropped and centered) and optionally the pictures from camera 20 are uploaded via wired or wireless link 40 and the Internet 14, to server computer 12. Server computer 12 maintains the pictures and portraits in database 42 for access by authorized individual users. Typically, there are several people who will have access to any particular portrait picture in database 42 for incorporation in family trees developed and displayed locally (on display 16) by the individual users. Accordingly, where a portrait picture is previously stored in database 42 of server computer 12, the using of the computational device 10 to access a portrait or picture includes operating the device to communicate with server computer 12 over the global computer network 14 known as the Internet.

Again, a user operates computational device 10 to trigger a storing of a cropped portrait. The cropped portrait may be stored in memory or store 36 of the computational device and/or in the server database 42. The storing of a cropped portrait may be automatically implemented upon the operating of the peripheral 18 to designate the location above the person's head and the computation of the portrait's perimeter.

The size of the individual's facial image in the cropped portrait depends on the feature that is selected. The portrait is proportioned automatically so that the selected feature is at or near the geometric center of the portrait. Consequently, if the mouth is selected, the face is smaller relative to the frame of the picture than if the nose or eyes are selected. With the eyes selected, the face occupies a maximum area of the portrait, thus giving the impression of intimacy or closeness of the individual portrayed.

A more precise description of the function of cropping module 30 is that generating a cropped portrait of a picture from picture store 22 includes registering or storing in portrait store 36 pixel values of the picture image from an area of the picture image having a length and a width (or other dimensions, for non-rectangular portrait perimeters) in predetermined ratios with respect to a distance between the designated location of the selected facial feature and the designated location above the respective pictured person's head.

Computational device 10 may specify a particular feature that the user is to locate on a picture from picture store 22 that is reproduced on display 16. The computational device 10 prompts the user, for instance, to click on the mouth of a selected individual's image in a picture from store 22. The computational device may prompt the user thereafter to click on a point just above the head of the selected individual's image. Upon the user's identification of the mouth's location and the top of the individual's head in the displayed image, cropping module 30 (whether resident on computational device 10 or server computer 12) generates a cropped portrait with the prompted facial feature at the center of a portrait having a perimeter having a predetermined shape and predetermined proportions.

As further depicted in FIG. 1, electronic computational device 10 includes a tree generation module 44 enabling a user to develop a family tree including at least one member at each of a plurality of generational levels. Module 44 is connected to display 16 via driver(s) or interface 34 for enabling a user to construct and view a family tree preferably with family tree members depicted via portraits with minimal text, preferably only including the birth and death year above the portrait picture and the first name below the picture. This technique emphasizes the likenesses of the family members and de-emphasizes genealogical display such as like family names.

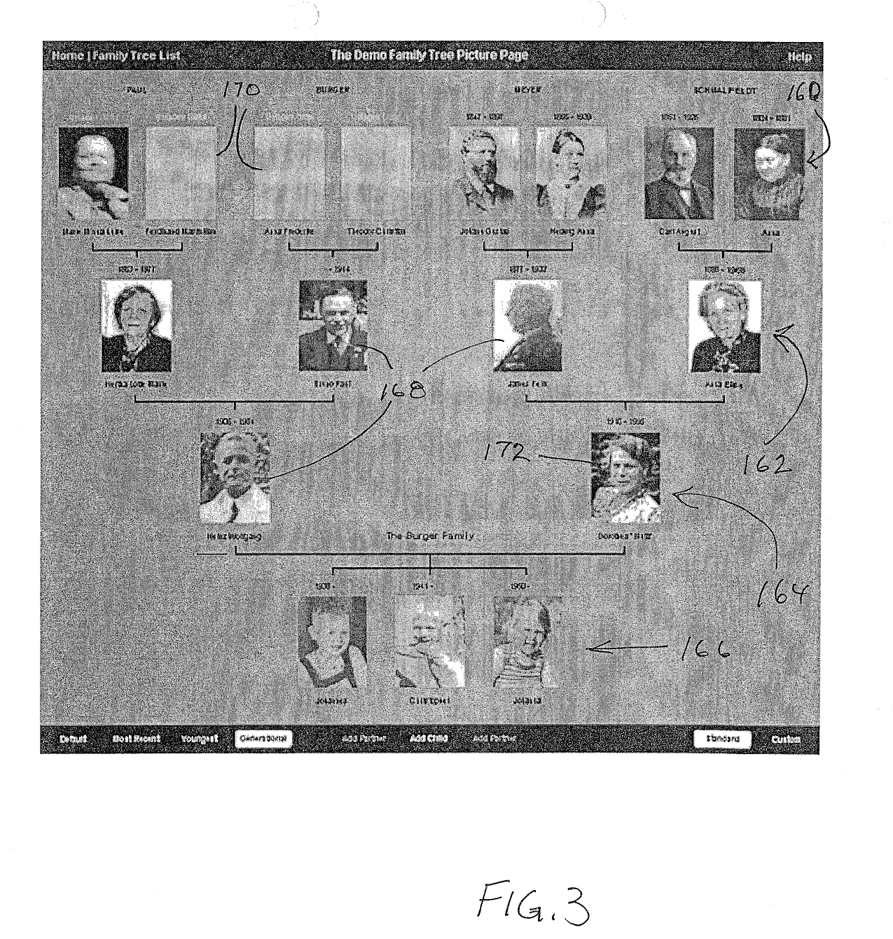

As depicted in FIG. 3, the present system contemplates a vertically oriented display of four generations. Four generations equals the typical “social memory” of children. The generations are the great grandparents at the highest level 160 (typically 8 great-grandparents), the grandparents at the next highest level 162 (typically four grandparents), the parents at the third level 164 and their children at the lowest level 166. The relationship between the “parents” is generic and can originate in genealogical or social bonding including multiple partners. All siblings and parent-associated children are displayed in the fourth descending level 166 (the “children level”). Displaying children associated with only one pair of partners, which are positioned on the parent or third level, condenses the genealogical aspect of relationship trees and makes the display more personal. (Note that children may be displayed (carried over) although being from another marriage.) Any recorded sibling of any selected individual can be displayed with the selected individual at the children level.

Family members are added in genealogical order or as social partnerships and a person's or a family's name can be freely chosen. Only first names are used for labeling the pictures making the portraits very personal. The family picture tree is explored by clicking on any person's pictures, their names and dates or by clicking on the centrally located family name. Generations are displayed (see below) as family members having an appropriate age differences of 20-30 or -40 years.

As further depicted in FIG. 3, a family tree includes portraits 168 that are age-indexed to the generational level 160, 162, 164, 166. Silhouettes, graphic images, or other stock pictures 170 are displayed where no pictures of an individual family member are available (for instance, where the family member is a remote ancestor).

In response to user instructions, identified by module selector 28, tree generation module displays a family tree on display 16. Operating peripheral 18, a user selects individual portraits to be incorporated into a tree. A portrait selection module 46 at the output of module selector 28 accesses portrait store 36 and extracts desired portraits therefrom for insertion by tree generation module 44 on a displayed tree. Tree generation module 44 accesses a data store 48 for family tree data, including an identification of individuals in the user's family tree, the relationships of the individuals to the user, and the birth and death years. Stored family tree information may also include user preferences, such as the social closeness of each individual to be displayed in a tree and, where there are multiple portraits at any one generational level, a preferred portrait for display. When a family tree is being built up for the first time, tree generation module 44 prompts the user to input the tree data and loads the data into tree data store 48.

More specifically, the way the objects (persons) are generated and a picture tree template (3 kinds, see below) assembles the objects, tree generation module 44 requires only one first object, which is the default user of the site. When a user creates an account with a name and gender, typically on server computer 12, a default object is generated. Initially, this object is displayed in an empty picture tree template at the parent level appropriate to its gender flag. This is the start of the family tree. Persons are added in the picture tree template at specific locations determining the relationships to this first object, etc. This procedure is well known in the art as it is being followed by other genealogical sites.

A tree template is configured to enable insertion of “additional” information for the relationship of surrounding objects—like every conventional genealogical site does. But such a template does not need a certain quality of the partner relationships (social and other partnerships). The present family picture tree system contemplates the provision of three tree architectures: maternal (matriarchal: females towards the center of all generations), paternal (patriarchal: males towards the center in all generations) and free form (persons are added in any generation without gender limitations).

There is also stored (e.g., in database 42) a list (“tree list”) of all objects of a given tree. If any person of this list is selected that person is inserted at the parent level according to its preferred tree architecture and all other available objects available in the database assemble around it by automated requests from a template script.

Any person in a tree can be invited as a member, i.e., he or she is already an object in the database 42. After setting up the account, the member object is verified and becomes the default object for the member and is displayed at the family level, and all available other objects assemble around it.

Electronic computational device 10 includes an age indexing module 50 that is activated by module selector 28 in response to prompting by tree generation module 44 or instructions input by a user via peripheral 18 and register 26 when the user wishes to tag portrait pictures in portrait store 36 with age information. The age information may take the form of exact or approximate ages, age ranges, or generational levels of the individuals as represented in the respective portrait pictures. Pursuant to the last indexing schedule, age-indexing module 50 interacts with the user to designate family members in their different stored portraits as being of the child, parent, grandparent or great-grandparent generational level. Alternatively, where age ranges are used as the primary designation, individual family members in their different stored portraits are identified as being in a 0-to-20, a 21-to-40, a 41-to-60, a 61-to-80, or an 81-to-100 age range.

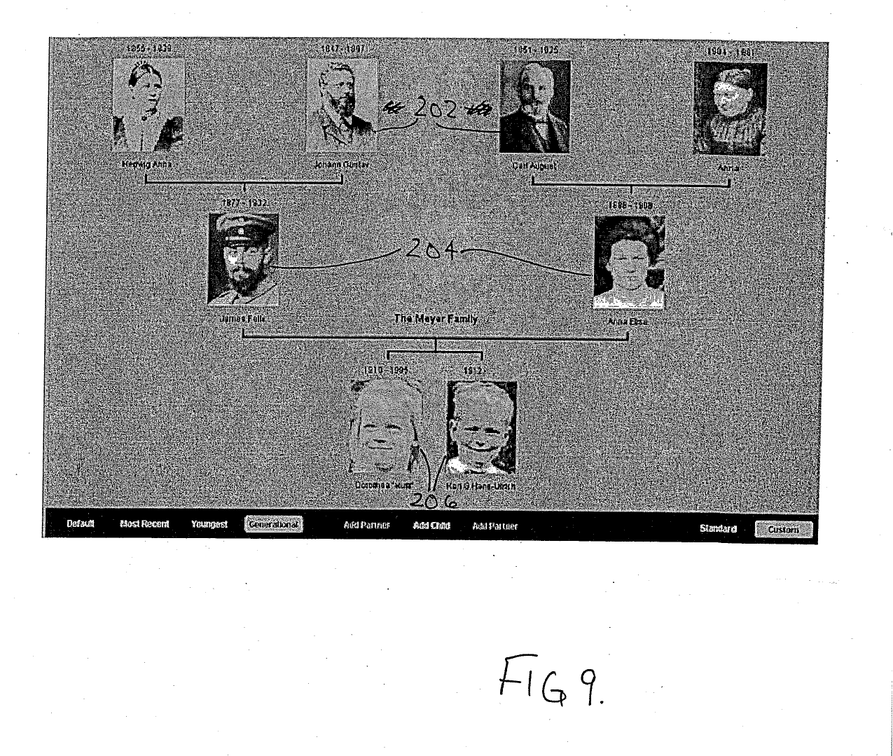

Electronic computational device 10 further includes an a social closeness indexing module 52 that is activated by module selector 28 in response to prompting by tree generation module 44 or instructions input by a user via peripheral 18 and register 26. For each individual family tree member other than the user, the user identifies that individual as neutral, personal or intimate depending on how close the user feels to the individual. Social closeness indexing module 52 stores the selected closeness values for the different family members in portrait stores 36. Pursuant to the user's preferences, the portraits of individual family tree members are shown (a) neutrally with the mouth at the center of the portrait as in the grandparent portraits 202 in FIG. 9, (b) personally with the nose at the center as in the parent portraits 204 in FIG. 9, or intimately with the eyes at the center as in the children portraits 206 in FIG. 9.

Tree generation module 44 thus accesses a database comprising portrait store 36 that stores, for each of a plurality of family tree members, one or more portrait-type pictures each assigned a respective predetermined age index by module 50 and depicting the respective family member within an age range corresponding to that respective age index. Each family member may also be assigned a social closeness index by module 52 that specifies the degree to which the facial image of the person fills up the available space of the portraits of that person.

Tree generation module 44 controls the display on a screen 16 of electronic device 10 a family tree having a parent level and showing portrait pictures from the database or store 36 of members of the family tree, wherein the displayed pictures have age indices matching generational levels of the members of the family tree so that family members of a generational level above a given generational level appear to be between approximately 20 years and approximately 40 years older than family members of the given generational level. Peripheral 18 (typically mouse or touch-screen) is used to select a family member on a generational level other than the parent level. In response to that selection, tree generation module 44 displays a modified family tree on screen 16 wherein a portrait picture of the selected family member having a parent-level age index is displayed at the parent level and wherein portrait pictures of other family members from the previously displayed family tree are positioned at new generational levels different from respective generational levels in the first family tree and with age indices consistent with the new generational levels and with the display of the selected family member at the parent level.

In the present system, the selection of the new parent-level family member on the first family tree display may require two mouse clicks or screen touches. In one embodiment of the system, where the desired individual is a grandparent or great-grandparent in the first family tree, a first click or touch moves that individual to the child level, with a portrait having a child age-index, if available. A second click or touch on the image at the child level, causes tree generation module 44 to move the selected individual to the parent level, with the selected individual's portrait having a parent-level age index (if available) and with other depicted family members having respective adjusted age indices.

In other words, clicking on a parent or an antecedent displays that selected person as a child, on the children level 166 (FIG. 3), together with all siblings and three generations of ancestors. For example, clicking on the mother 172 in the tree display of FIG. 3 results in a modified family tree (FIG. 4) displaying her at 174 with her sibling at 176 as children and reveals at the top a new row of great grandparents 178 (see below).

It is possible that, for one or more family members, pictures of that family member at one or more of the generational levels may not be available. In that event, tree generation module 44 may be configured to select a portrait picture in portrait store 36 with an age index closest to that of a missing generational level. Where portrait pictures with both older and younger age index values are available, the older one may be automatically selected for use in a family tree display. If no pictures of an individual family member are available (for instance, where the family member is a remote ancestor), a silhouette, graphic image, or other stock picture may be used. Such silhouettes, graphic images, or other stock pictures may be stored in encoded form in tree data store 48.

As discussed above, portraits and tree data may be stored centrally in database 42. In that scenario, electronic device 10 is operated to communicate with server computer 12 to download portrait pictures for the various versions of a family tree. It is contemplated that the using of peripheral 18 to select a family member includes operating the electronic device to position a cursor on the selected family member's portrait picture in a displayed family tree.

Electronic device 10 includes a portrait library review module 54 for providing a user with a novel kind of portrait review capability. Module 54 is connected to portrait store or database 36 and to display 16 for showing on the display different collections of portrait pictures where each collection shows the same individual family tree members as the other collections, and where the family tree members of the displayed portraits of any one collection have the same age index, which is different from the age indices of the other collections. Thus, a first collection of the portrait pictures from the database, wherein the displayed portrait pictures are of respective ones of the individuals and all share a common age index, and operating the computer to select a different age index. In response to the selecting of the different age index, a second collection of the portrait pictures from the database is displayed on the display, wherein the portrait pictures of the second collection are of the same individuals as depicted in the first collection and have the selected different age index.

Accordingly, a collection of portraits shown on display or screen 16 under the control of portrait library review module 54 may typically include members of different generations. Thus, child portraits of parents and grandparents may be displayed together with contemporaneous child portraits of individuals who are still currently children. This functionality is of interest in tracing resemblances across generations and in contrasting such personal attributes as hair style, clothing style (collars and shirts), hats, if any, etc. across generations.

A collection of portraits of the same age index may be presented on display 16 by portrait library review module 54 in any order or arrangement desired. One could, for instance, use a tree-type hierarchy or a modified tree hierarchy. In both cases, individuals of different generations are displayed in different rows. Thus, current children would be presented on a lowermost row, with parents, aunts and uncles (all shown as children) in a row immediately above, and grandparents, great-uncles and great-aunts on the next row above, etc. Alternatively, one could arrange family members of the female gender in one area and males in another area. The user may be provided with the option of selecting or constructing his or her preferred arrangement of portraits.

Where the individuals are assigned a preselected social closeness value or index defining a degree to which an associated facial image fills available space within a perimeter of the respective portrait picture, the displaying of the different collections may entail displaying portrait pictures of selected individuals in accordance with respective preselected social closeness values or indices.

The present portrait generation and display system contemplates that the portrait pictures may be periodically updated (preferably annually) to maintain a current inventory of contemporaneous likenesses. For the childhood years, one might store portrait pictures at least for baby, toddler, child, and teenager age ranges. Most likely, users will wish to update at least the children photos annually.

It is to be noted that portrait library review module 54 may depict persons that are siblings, uncles or aunts, or great uncles or aunts. Depending on the person(s) selected for the parent level of a family tree on display 16, the tree may shown other people that are not depicted in the first displayed tree.

As discussed above, age-specific portraits display module 54 allows a user to view on one page all included persons at the same selectable age, if available. If not available, the closest age is displayed. Such a display has great positive and reinstating impact on the viewer. The family tree picture page produced under the direction of tree generation module 44 has a limited age selection (default, most recent, and youngest) because of the rarity of pictures for older generations. However, templates may be provided for relatives, members and friends where more differentiated age ranges can be selected (for instant, most recent, baby, ages 1-2, ages 3-4, ages 5-7, ages 8-10, ages 11-15, ages 16-20, ages 21-30, ages 31-40, ages 41-55, ages 56-70, ages 71 and over). The relative template has the additional options of living only (default) and all relatives.

Electronic device 10 further comprises a life story generator 56 operatively connected to portrait store 36 and display 16 for enabling a user to develop, edit and save a life story consisting of at least one portrait from store 36 and textual material entered via peripheral 18 or downloaded in part from database 42. Life story generator 56 accesses portrait store 36 (or database 42) to retrieve and show on display 16 a collection of the portrait pictures of a single one of the individuals (any family member for which the individual wishes to construct, or contribute to, a life story) and have respective age indices. The portrait pictures of the collection are displayed in a chronological sequence, for instance, in a vertical array along the left-hand margin of the displayed page. Biographical textual material is entered in a column along the right-hand side of the page. It is contemplated that the textual subject matter corresponds in time-line fashion to the age indices of the portraits, so that the textual material appears on the display adjacent or aside the respective portrait pictures of the collection.

Life story generator 56 may be operative to insert multi-media material in addition to text in the life story. One or more multi-media inputs 58 are connected to life story generator 56 for providing that unit with photographic, audio, audio-visual and other data formats to insert into the life story, at appropriate points relative to the age sequence of portrait pictures.

A constructed life story may be retained in a storage unit 60 of electronic device 10 and/or may be transmitted to server computer 12 for storage in database 42, whereby access by other authorized individuals, generally but not necessarily family members.

A portrait-centered life story template, stored in store 60 and/or database 42 provides a simple, age- and year-organized way for collection of facts and pictures that illustrate the life events at a certain age range. A default comment field may be provided by default for each person to record snippets of data. A life story information field is provided if a person is associated with one or more portraits. It assembles all available portraits by age/year in rows extended by an editing field with formatting links. Links may be provided to allow an authorized life story editor to add/edit headings lines, to edit/delete content, to insert pictures and other multi-media data, and to merge/unmerge the field below. Larger story fields can span several portraits. A linked text is provided at the top of the life story to edit/save. It reveals or hides the editing links.

A portrait-centered life story template provides a simple, age- and year-organized way for collection of facts and pictures that illustrate the life events at a certain age range. A default comment field may be provided by default for each person to record snippets of data. A life story information field is provided if a person is associated with one or more portraits. It assembles all available portraits by age/year in rows extended by an editing field with formatting links. Links may be provided to allow an authorized life story editor to add/edit headings lines, to edit/delete content, to insert pictures and other multi-media data, and to merge/unmerge the field below. Larger story fields can span several portraits. A linked text is provided at the top of the life story to edit/save. It reveals or hides the editing links.

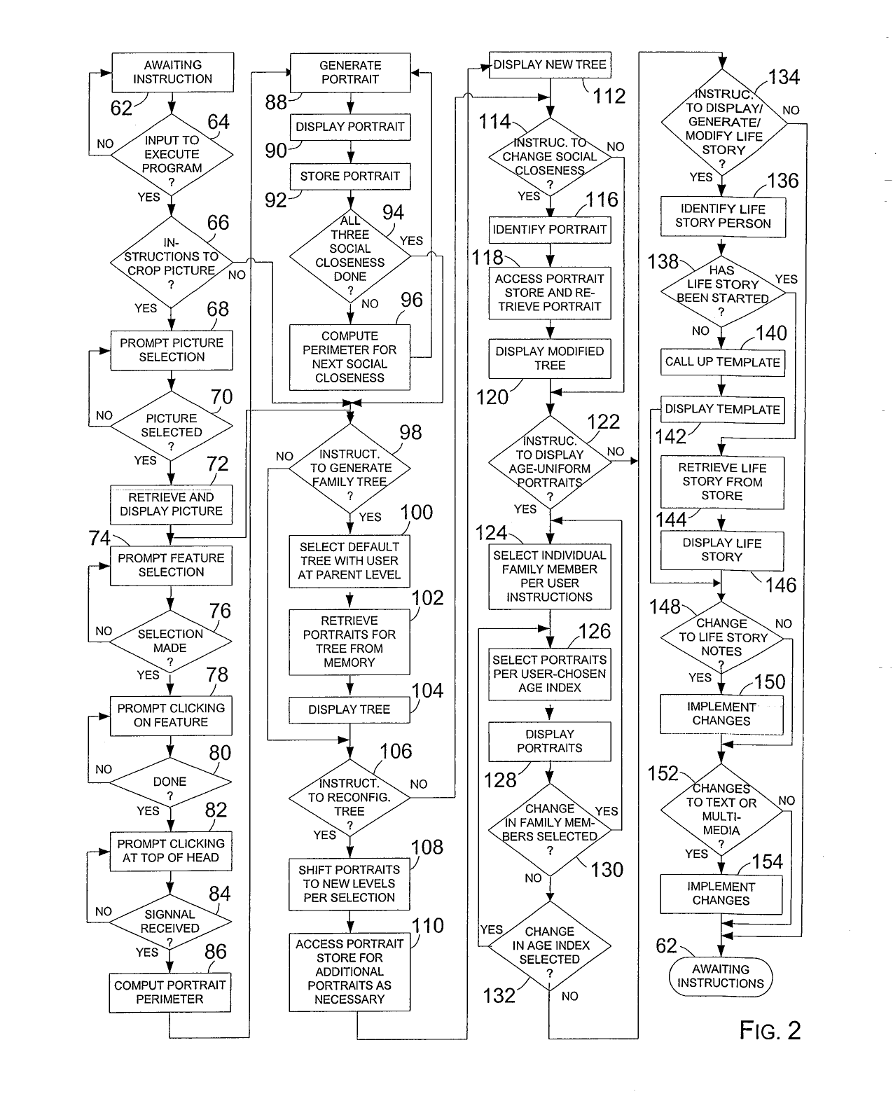

The various modules of FIG. 1 may be implemented in the form of generic microprocessor circuits modified by programming to carry out the described functions. FIG. 2 depicts a series of operations carried out by microprocessor circuits under instructions of specialized software.

In a dormant operating mode 62, programmed electronic device 10 awaits a request or order to carry out program instructions. If such a request or order arrives from a user, as determined at a decision junction 64, electronic device 10 (and particularly module selector 28) makes an inquiry 66 as to whether the incoming request or order is to crop a picture. If so, electronic device 10 (particularly picture selector 32 and/or cropping module 30) provides a prompt 68 to the user to select a picture from store 22. Once a selection has been made, as determined in an inquiry loop 70, picture selector 32 retrieves the selected picture from store 22 and cropping module 30 shows the selected picture on display 16, in a step 72. In an optional step 74, cropping module 30 then provides a prompt or instruction to the user via display 16 to select a feature for center cropping. Thus, the user may select the mouth, nose or eyes, as determined at a decision junction 76. In a step 78, cropping module 30 instructs the user to click on the user-selected feature of a target individual shown in the selected picture on display 16. Alternatively, cropping module 30 may automatically instruct the user to click on (or otherwise identify) the mouth of a facial image in the selected picture, without giving the user the option of selecting another feature. Upon determining in an inquiry 80 that the user has clicked on the selected or presented facial feature, cropping module 30 prompts the user at 82 to click on (or otherwise identify) a point at or just above the top of the pictured individual's head. Once the signal is received, as determined at a decision junction 84, cropping module 30 computes the portrait perimeter at 86, generates the portrait in a pixel-extraction step 88, shows the portrait on display 16 in a step 90, and stores the portrait in portrait store 36 in a step 92.

In a subsequent inquiry 94, cropping module 30 determines whether all three social closeness portraits—mouth centered, nose centered and eyes centered—for the selected individual have been generated. If not, cropping module 30 computes a portrait perimeter for at least one other social closeness index in a step 96 and repeats steps 88, 90, and 92 for the new portrait.

After all portraits have been generated and stored, electronic device 10 and particularly module selector 28 entertains an inquiry 98 as to whether the user has requested the generation of a family tree. Inquiry 98 is also entered upon if module selector 28 determines at inquiry 66 that there is no cropping request.

If there is a request to generate a family tree, as determined at inquiry 98, module selector 28 induces tree generation module 44 in a step 100 to select a default tree with the user depicted at the parent level. Tree generation module 44 first checks tree data store 48 (or database 42) to determine whether a tree has already been constructed and, if so, retrieves the relevant portraits from portrait store 36 in a step 102 and causes display 16 to show the tree with the proper portraits in a step 104. If the user has not yet built his or her family tree, the selection of portraits in step 102 entails only the owner's default portrait placed in the family level. Pursuant to conventional tree building processes, individual family members are treated as objects that have the identification tags for the related objects (other family members) attached. If a user starts with one object (e.g., himself or herself), all the objects with corresponding tags will assemble automatically.

After the display of a family tree in step 104, module selector 28 determines at a decision junction 106 whether the user has entered an instruction to reconfigure the displayed tree. Decision junction 106 is also executed if the inquiry 98 as to whether the user has requested the generation of a family tree has a negative outcome.

If there is a user-generated instruction to reconfigure a displayed family tree, as determined at decision junction 106, tree generation module 44 shifts the displayed family members to different levels in a step 108 and accesses portrait store 36 in a step 110 to obtain substitute and additional portraits, as warranted. Generally, the reinstallation of a family member at a different generational level in a displayed family tree entails the retrieval of a new portrait that is age-indexed to the new generational level.

The modified tree with the shifted family members is displayed in a step 112. Thereafter, module selector 28 checks in an inquiry 114 whether the user has entered a request to enter or change a social closeness value for a portrait on a displayed family tree. A positive outcome to the inquiry leads to an identification of the desired portrait in a step 116, an accessing of portrait store 36 and a retrieving of the portrait with the desired social closeness value in a step 118, and a modification of a displayed family tree in a step 120 to show the retrieved portrait with the new social closeness index. This social closeness modification also causes electronic device 10 to change the default social closeness value for the respective individual family member as appearing on displays by the respective user. In future family tree displays, portraits or the respective individual family member having the new default social closeness value will automatically be selected for display.

The Standard option displays the neutral social type. The social type display selection is stored in a user-specific fashion and has the advantage to always display close relatives and friends with a desired psychological closeness impact and distinguish them from other persons of less familiarity.

After the completion of the social index change at step 120 or a determination at inquiry 114 that there is no outstanding request to modify a social closeness index, module selector 28 enters a decision junction 122 as to whether the user has entered a request to display a collection of portraits with the same age index. Upon an affirmative result at decision junction 122, module selector 28 engages portrait library review module 54 in a step 124 to determine upon a set of family members selected by the user, together with a desired age index. Module 54 retrieves from store 36 a set of portraits for selected family members all having the same age index in a step 126 and induces display 16 to show the selected portraits in a step 128. Selector module 28 then determines in an inquiry 130 whether the user has requested a change in the set of family members. If so, portrait library review module 54 again executes steps 124, 126, and 128. If not, module selector 28 inquires at 132 whether the user has selected a different age index. If so, portrait library review module 54 again executes steps 126 and 128, in accordance with the new age index.

A negative outcome at decision junction 122 or inquiry 132 leads to a check 134 by module selector 28 as to whether the user has entered an instruction for displaying a life story. If so, module selector engages life story generator 56, which interacts with the user to identify the desired individual in a step 136, and to inquire at 138 whether a life story has bee started for the selected individual family member. If no one has started a life story for the selected individual, as determined by generator module 56 by accessing life story store 60 or database 42, life story generator 56 calls up and displays a life story template in steps 140 and 142. If a life story has been started, generator 56 retrieves the respective life story from store 60 or, more preferably, database 42, in a step 144 and displays the retrieved life story in a step 146.

Generator 56 then inquires of the user in a step or inquiry 148 whether the user wishes to make any change to the notes portion of the displayed life story. In a step 150, generator 56 implements notes changes under the direction of the user and incorporating material entered via input 58.

Generator 56 finally inquires of the user in a step or inquiry 152 whether the user wishes to make any change to the textual and multi-media portion of the displayed life story. In a step 154, generator 56 implements text and multimedia changes under the direction of the user and incorporating material, if any, entered via input 58.

Device 10 then re-enters dormant or waiting mode 62, if there are no outstanding instructions to decoded by module selector 28.

It is to be noted that an automatic picture cropping in accordance with the present invention preferably requires identification of exactly two points of reference on a facial image included in a picture. One point is any readily identifiable feature on a person's face, such as the middle of the mouth, the tip of the nose, or a point between the eyes. The other point is located just outside the person's head, preferably, at the top of the head. It is possible with pattern recognition software to just identify a facial image in a picture that may include one or more facial images and order the computation device to crop the picture. Pattern recognition software can identify the facial features and the outlines of the head. Pattern recognition software can enable the automatic identification of the mouth and the top of the head, so that the portrait can be automatically cropped in accordance with principles explained above.

It is to be noted further that a portrait or cropped picture may have any desired perimeter, such as a rectangle, an oval, a diamond or rhombus, a heart shape, etc. Optionally, the type of perimeter may be selectable by the user. The same perimeter type may be used for all portraits of a family tree, or may vary in accordance with the preferences of the user.

In a family tree display under the control of module 44, display of other related persons in a family (e.g., aunts, uncles, cousins) may be enabled through a click-selection of portraits. Persons selected in the upper three rows may be displayed at the children level together with their siblings. Children selected from the fourth row are displayed at the parent level and they are shown together with partners if available and their children if available.

Preferably, the family names or surnames are displayed in a family tree only at the family or parent level as a generic family descriptor (The Smith Family) and above the great grandparent level. Since either married family names or maiden names (or any combination thereof) can be used in a person's profile they are only identified by their first names (given names) making the template easier to read, more compact and more personal.

Display of additional spouses by tree generation module 44 may be made available through an “Additional Spouse Tab” placed next to a person at the parent level. This provision compacts the display of the genealogical relationships tree and makes the family tree easier to navigate.

Access to textually presented information as to any displayed family tree member may be provided on a family tree through links embedded in the text of the template. For instance, the pair of birth and death dates placed above a given portrait may be linked to the life story of the respective individual. The given names placed underneath the portraits in the top three generations may be linked to profiles of the respective parties. Such profiles can include the parties' respective collected portraits, the parties' respective life stories, the parties' relatives, and the status of the parties' membership in the family tree. The given names placed underneath the portraits in the fourth or bottom generation (the children) may be linked to the relative pages of that child. In between portraits at the family or parent level is listed the name of the family displayed. The family name is linked to a family photo album collection. An upper tool bar has navigation and help links, a lower tool bar provides for the display of certain personal or generational ages and of the social portrait types.

The interactive family tree display system of the present invention preferably relies on WWW2.0 technologies that are widely used for collecting and displaying social and genealogical information. These technologies allow users to connect with personal computing devices through the Internet to web servers and to display in web browser applications information that is available in databases of the servers.

An online service as disclosed herein provides controlled access to interactive unique web page templates that allow users (1) to display relationships between people in uniquely arranged genealogically trees centered on the family, (2) to generate and collect yearly “social portraits” of persons, (3) to depict temporal relationships in individuals' life within generations' time spans (“Living Picture Trees”), (4) to write illustrated life stories organized with yearly portraits, and (5) to collect and access related information—like relatives, event photo albums, and documents.

It is contemplated that each real-life person that joins or subscribes to a web-based family-tree service as described herein becomes a user by creating a user account. Users can create their own family trees and automatically become members of their own trees in addition to members of relatives' trees. Family tree members can invite new users to join the service and become members of their trees or friends. Members, depending on their level of authorized access to a family tree can view and add data including persons, portraits, albums, and life story information.

Optional additional services provided in a family picture tree website as described herein may include photo albums which are generated from uploaded and cropped pictures and collected at the family level, accessible from a website home page or a centrally located family name in the family picture tree (see FIGS. 3, 4, and 9).

In addition, the home page may display as family news sequentially all activities recently performed by members of a family tree. It provides a meeting point for the entire greater family to exchange updates on family related data, portraits, albums and life stories.

It is contemplated that an account is created is free of charge. Each user starts his or her own family tree and can invite other relatives to be members of the tree. At the sole discretion of the owner, invited members can be provided with different access rights to contribute or invite others to join the community. Thus, in a short time dozens of members can be participating in a tree and share their heritage and their families. Friends can be invited to join but will have only limited viewing access.

Website usage rules may require that any user of the family picture tree website be at least 13 years old and open an account. This requires a valid e-mail address and a password. The registered user must either create a new family picture tree or be invited to join an existing family tree, entailing an identification as a member of that tree. It is contemplated that none of the information submitted to this site is public, publically available or searchable. No other account holder is permitted access to any data submitted by an owner of a tree except in the case that the owner specifically invites other account holders as members or friends. This means that the owner of a family picture tree has exclusive control over privacy. All of the submitted information, including names, dates and e-mail addresses, will be kept private and will not be made available to third parties. In addition, all information transferred to and from this web site is secured with an SSL Certificate encryption (Secure Encrypted Communication: https).

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A method for cropping pictures, comprising:
using an electronic computational device to access a picture in electronic form including an image of a person's face showing the person's head and facial features;
displaying said picture on a display of said computational device;
using an input peripheral of said computational device to designate or identify a location of a selected one of the person's facial features on said picture;
further using said peripheral to designate a location above the person's head; and
operating said computational device to trigger an electronic cropping of said picture to generate a cropped portrait wherein said selected one of the person's facial features is located at a predetermined position in said cropped portrait and wherein an upper margin of said cropped portrait is at least proximate the designated location above the person's head.

2. The method defined in claim 1, further comprising operating said computational device to trigger a storing of said cropped portrait.

3. The method defined in claim 2 wherein the storing of said cropped portrait is automatic with the operating of said peripheral to designate the location above the person's head.

4. The method defined in claim 3 wherein said computational device has computer network access capability, the using of said computational device to access said picture includes operating said computational device to communicate with a server computer over a computer network, the operating of said computational device to trigger a storing of said cropped portrait comprising operating said computational device to transmit a signal to said server computer.

5. The method defined in claim 2, further comprising operating said computational device to trigger a storing of at least one additional cropped portrait, said additional cropped portrait being centered on another one of the person's facial features.

6. The method defined in claim 5 wherein said selected one of the person's facial features is the person's mouth, said another one of the person's facial features being the person's nose, further comprising operating said computational device to trigger a storing of at least a second additional cropped portrait, said second additional cropped portrait being centered on the person's eyes.

7. The method defined in claim 1 wherein the operating of said computational device to trigger said electronic cropping is automatically executed upon the operating of said peripheral to designate the location above the person's head.

8. The method defined in claim 7 wherein said computational device has computer network access capability, the using of said computational device to access said picture includes operating said computational device to communicate with a server computer over a computer network, the operating of said computational device to trigger said electronic cropping including dispatching a signal from said computational device to said server computer.

9. The method defined in claim 1 wherein the cropping of said picture to generate said cropped portrait is executed by said computational device.

10. The method defined in claim 1 where said peripheral is a computer mouse, the operating of said peripheral to designate or identify a location of said selected one of the person's facial features on said picture including pointing and clicking on said selected one of the person's facial features.

11. The method defined in claim 1 wherein said peripheral is a touch pad or screen, the operating of said peripheral to designate or identify a location of said selected one of the person's facial features on said picture including touching said pad or screen at the image of said selected one of the person's facial features.

12. The method defined in claim 1 wherein the operating said computational device to generate a cropped portrait of said picture includes registering or storing, from said image, a pixel area with a length and a width in predetermined ratios with respect to a distance between the designated location of said selected one of the person's facial features on said picture and the designated location above the person's head.

13. A method for representing a family tree including at least two members at each of a plurality of generational levels, comprising:
at least indirectly accessing a database that stores, for each of a plurality of family tree members, a plurality of portrait pictures each assigned a respective predetermined age index and depicting the respective family member within an age range corresponding to that respective age index;
displaying on a display screen of an electronic device a first family tree showing portrait pictures from said database of members of said family tree, wherein the displayed portrait pictures have age indices matching generational levels of the members of said family tree so that family members of a generational level above a given generational level appear to be between approximately 20 years and approximately 40 years older than family members of said given generational level, said family tree having a parent level;
using an input peripheral of said electronic device to select a family member on a generational level other than said parent level; and
thereupon displaying on said display screen a second family tree wherein a portrait picture of the selected family member having a parent-level age index is displayed at the parent level and wherein portrait pictures of other family members from said first family tree are displayed at new generational levels different from respective generational levels in said first family tree and with age indices consistent with the new generational levels and with the display of said selected family member at said parent level.

14. The method defined in claim 13 wherein each of the family tree members are assigned a preselected social closeness value or index defining a degree to which an associated head image fills available space within a perimeter of the respective portrait picture, the displaying of said first family tree and said second family tree including displaying family portrait pictures of family members in accordance with respective preselected social closeness values or indices.

15. The method defined in claim 13 wherein said electronic device has computer network access capability and wherein said database is associated with a server computer, the accessing of said database including operating said electronic device to communicate with said server computer via a computer network, the displaying of said first family tree and said second family tree each including operating said electronic device to download portrait pictures for said first family tree and portrait pictures for said second family tree in encoded form from said server computer, the using of said peripheral of said electronic device to select said family member including operating said electronic device to transmit a request to said server computer to produce, and transmit to said electronic device in encoded form, portrait pictures of family members for said second family tree in accordance with a position of the selected family member in said first family tree.

16. The method defined in claim 13 wherein the using of said peripheral to select a family member includes operating said electronic device to position a cursor on the selected family member's portrait picture in said first family tree.

17. The method defined in claim 13 wherein said peripheral is taken from the group consisting of a computer mouse and a touch pad or screen, the using of said peripheral to select a family member including operating said peripheral to select a respective portrait picture displayed in said first family tree.

18. A computer method for reviewing an electronic photo library, comprising:
at least indirectly accessing a database that stores, for each of a multiplicity of individuals, a plurality of portrait pictures each assigned a respective predetermined age index and depicting the respective individual within an age range corresponding to that respective age index;
displaying, on a display screen of an electronic device, a first collection of said portrait pictures from said database, wherein the displayed portrait pictures are of respective ones of said individuals and all share a common age index;
operating said computer to select a different age index; and in
response to the selecting of the different age index, displaying on said display a second collection of said portrait pictures from said database, wherein the portrait pictures of said second collection are of the same individuals as depicted in said first collection and have said different age index.

19. The method defined in claim 18 wherein each of the individuals are assigned a preselected social closeness value or index defining a degree to which an associated facial image fills available space within a perimeter of the respective portrait picture, the displaying of said first collection and said second collection including displaying portrait pictures of selected individuals in accordance with respective preselected social closeness values or indices.

20. The method defined in claim 18 wherein the age indices of the portrait pictures in said database are defined by predetermined age ranges.

21. The method defined in claim 18 wherein the age indices of the portrait pictures in said database are approximate ages of the respective individuals when the respective portrait pictures were taken.

22. The method defined in claim 18 wherein the individuals of said first collection and said second collection have a predefined relationship to one another.

23. The method defined in claim 18 wherein the individuals of said first collection and said second collection are of different generations.

24. A computer method for communicating life stories, comprising:
at least indirectly accessing to a database that stores, for each of a multiplicity of individuals, a plurality of portrait pictures each assigned a respective predetermined age index and depicting the respective individual within an age range corresponding to that respective age index;
displaying, on a display of an electronic device, a collection of said portrait pictures from said database, wherein the displayed portrait pictures are of a single one said individuals and have respective age indices, the portrait pictures of said collection being displayed in a chronological sequence; and
operating said electronic device to insert biographical textual material in association with each of the displayed portrait pictures so that the textual material appears on said display adjacent or aside the respective ones of the portrait pictures of said collection.

25. The method defined in claim 24, further comprising providing operating said electronic device to insert pictorial and multi-media type material.
